(19) United States
(12) Patent Application Publication
(10) Pub. No.: US 2018/0362313 A1
(43) Pub. Date: Dec. 20, 2018

(54) AERIAL LIFT BASKET

(71) Applicant: HAULOTTE GROUP, L'Horme (FR)

(72) Inventors: Nicolas BONNEFOY, Saint Chamond (FR); Sebastian DITTUS, Mornant (FR)

(21) Appl. No.: 16/062,940

(22) PCT Filed: Dec. 16, 2016
(86) PCT No.: PCT/EP2016/081415

§ 371 Date: Jun. 15, 2018

(30) Foreign Application Priority Data
Dec. 18, 2015 (FR) 1562761

(51) Int. Cl. B66F 11/04; B66F 17/00; B60Q 1/24

(52) U.S. Cl. CPC B66F 11/044; B60Q 1/24; B66F 17/006

(57) ABSTRACT

This aerial lift includes a lower part equipped with members for connecting to the ground; a platform including a floor partially surrounded by a guardrail in which an access zone is provided; and a lifting structure supporting the platform. The platform is equipped with a lighting system, other than headlights, suitable for illuminating at least part of a space inside the platform, including at least the access zone.

The invention relates to an aerial lift.

Aerial lifts, and more generally mobile elevating work platforms (MEWP), comprise a platform mounted on elevating means making it possible to work at heights. During the winter season, work can be done under low light conditions, which involves using lighting.

It is known, in particular from DE-A-29 24 820, to equip an aerial lift with a light projector able to be attached on the railing of the platform to light the area or objects brightly on which the work must be done. Such a projector, for example known from JP-A-2012/158286, is bulky and is exposed to impacts because it is mounted on the railing. Furthermore, such a projector does not allow comfortable lighting, i.e., lighting allowing the person on the platform to direct the movements of the platform correctly relative to its environment and to distinguish the inside of the platform itself and the objects that may be stored there, the platform itself remaining dark.

The invention aims to resolve these drawbacks by proposing a new aerial lift, having improved access and working comfort under low lighting conditions.

To that end, the invention relates to an aerial lift including a lower part equipped with members for connecting to the ground; a platform including a floor partially surrounded by a guardrail in which an access zone is provided; and a lifting structure supporting the platform. This lift basket is characterized in that the platform is equipped with a lighting system, other than headlights, suitable for illuminating at least part of a space inside the platform, including at least the access zone.

Owing to the invention, people needing to access the lift basket and perform work therein can do so comfortably and safely enough in case of low lighting.

According to advantageous but optional aspects of the invention, such an aerial lift may incorporate one or more of the following features, considered in any technically allowable combination:
The lighting system of the platform comprises a first lighting device comprising at least one light source provided on a part of the guardrail separated from work zones of the platform, and emitting a beam of light oriented toward the inside of the platform;
The platform comprises a control console mounted on the part of the guardrail separated from the work zones, and in that the light source of the first lighting device is fastened on the control console;
The first lighting device is also suitable for lighting the immediate environment of the platform such that an operator present on the platform is able to move the platform relative to the lower part in an unlit environment;
The first lighting device illuminates the immediate environment of the platform located at the same height relative to the ground as the platform and in a horizontal direction, up to a distance of the platform at least equal to two meters;
The platform comprises a control console, and in that the lighting system of the platform comprises a second lighting device suitable for illuminating the control console;
The control console comprises a foldable protective cover, the inner side of which comprises reflective surfaces, suitable for diffusing, on the control console, the light produced by the second lighting device when the protective cover is in a raised position providing access to the control console;
The second lighting device comprises at least one light source fastened on the control console;
The platform comprises a third lighting device suitable for illuminating the immediate environment of the platform located below the platform;
The third lighting device comprises at least one light source fastened below a floor of the platform;
The activation of the lighting system of the platform can be controlled remotely from the lower part;
The lower part is equipped with a control console from which the activation of the lighting system of the platform is controlled, and the control console of the lower part is equipped with a device for lighting this control console.

The invention will be better understood, and other advantages thereof will appear more clearly, in light of the following description of an aerial lift according to its principle, provided as a non-limiting example in reference to the appended drawings, in which:

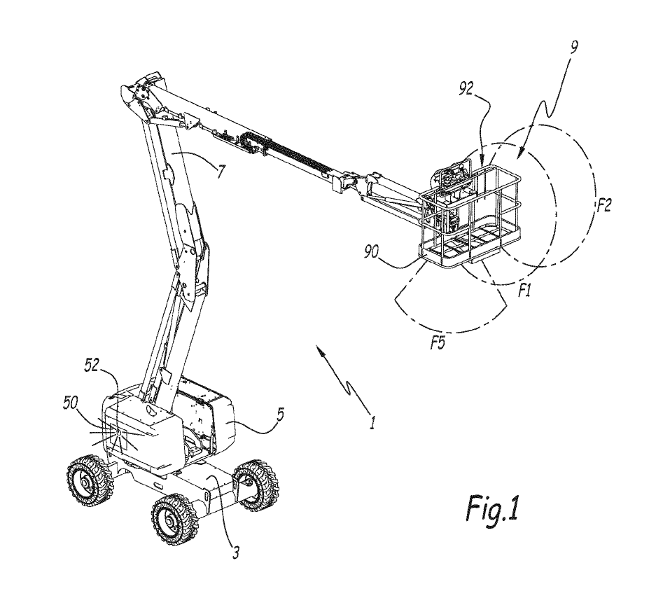

FIG. 1 is a perspective view of an aerial lift according to the invention;

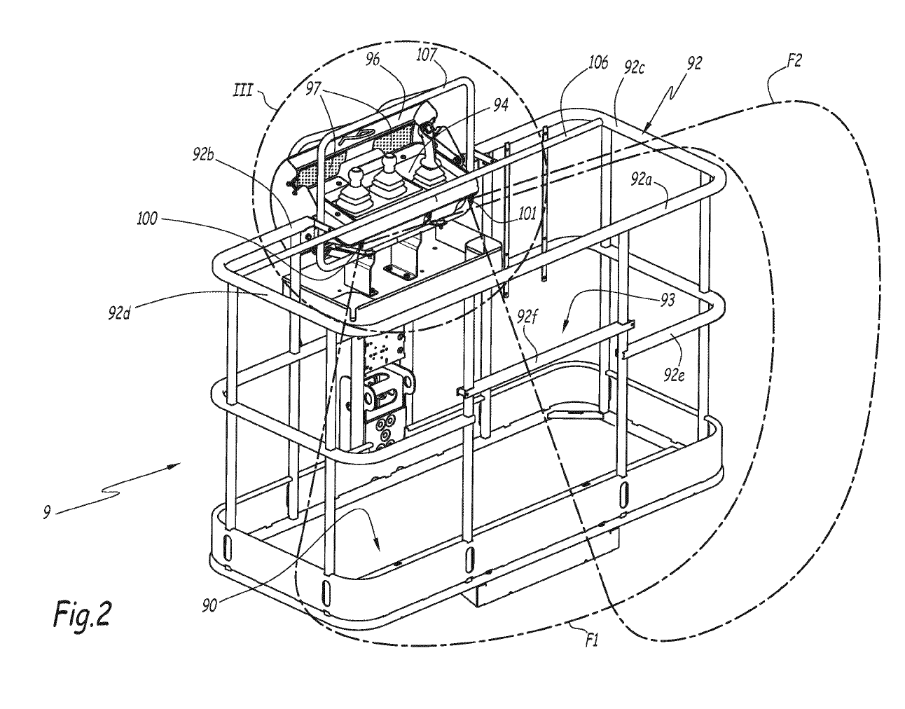

FIG. 2 is a perspective view of a platform of the aerial lift of FIG. 1;

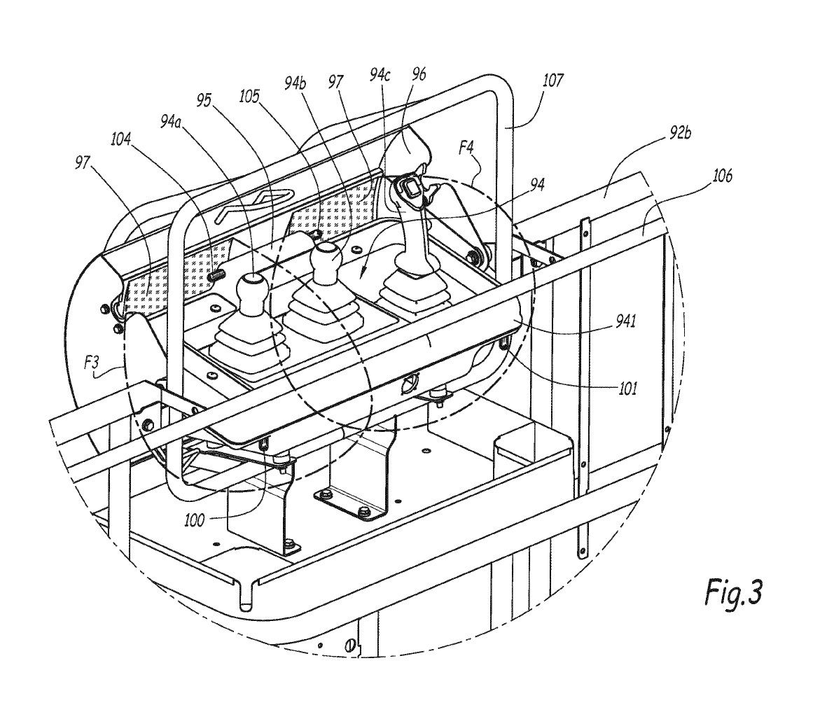

FIG. 3 is an enlarged view of detail III in FIG. 2 showing a control console of the platform of FIG. 2;

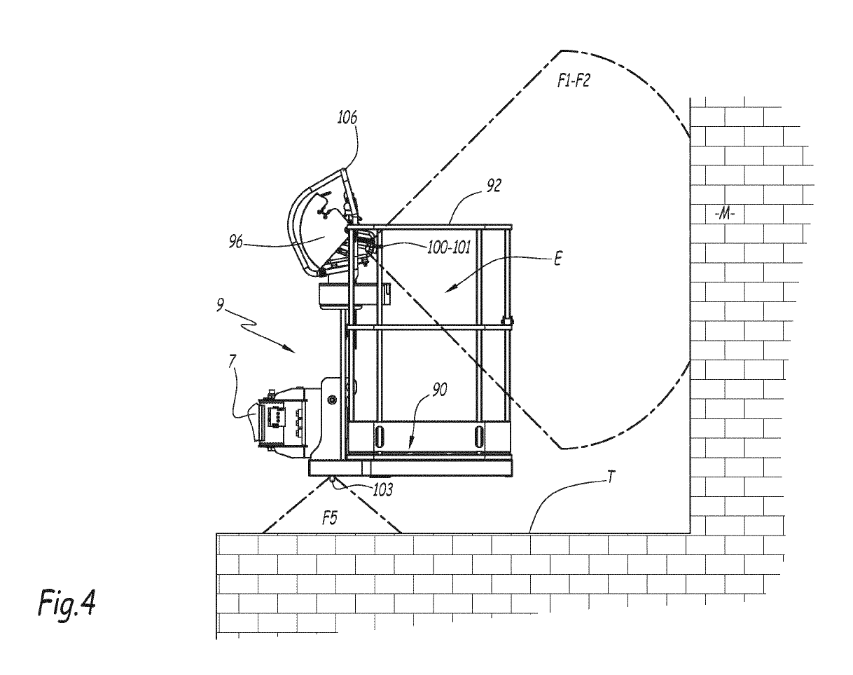

FIG. 4 is a side view of the platform of FIG. 2.

FIG. 1 shows an aerial lift 1 comprising a lower part including a chassis 3 equipped with members for connecting to the ground, such as wheels or tracks. The lower part also comprises a turret 5 rotatable relative to the chassis 3 along an axis perpendicular to the rotation axes of the wheels, a lift structure 7 and a platform 9, shown in FIGS. 2, 3 and 4, supported by the lift structure 7. The platform 9 comprises a wire floor 90 surrounded by a guardrail 92.

The guardrail 92 comprises an upper tube parallel to the wire floor 90 and formed by four sections including a rear section 92a, with a long length and located on the side opposite the connection of the lift structure 7 on the platform 9. An access zone 93 is preferably arranged on the side of the rear section 92a. The upper tube also includes a front section 92b opposite the rear section 92a, and oriented on the side of the lift structure 7. Between the sections 92a and 92b, two lateral sections 92c and 92d complete the upper tube. In an alternative that is not shown, the access zone 93 can be arranged on the side of one of the lateral sections 92c and 92d.

In the usage configuration of the lift basket 1, the operator(s) use a work zone located on the side of the sections 92a, 92c and 92d. These parts of the guardrail 92 are exposed to impacts and dirtying.

The access zone 93 is formed by a moving part 92f of a horizontal bar 92e of the guardrail 92, this moving part 92f being suitable for being raised and allowing a person to enter the platform 9. In an alternative that is not shown, the access zone 93 can be formed by an articulated gate relative to the guardrail 92.

The platform 9 is equipped with a control console 94 making it possible to control the aerial lift 1, in particular the movements of the platform 9 relative to the chassis 3, and which is mounted at the center of the front section 92b of the guardrail 92.

The terms “rear” and “front” are used in reference to the fact that when an operator is in front of the control console 94, the section 92d of the guardrail 92 is behind him.

According to the invention, the platform 9 is equipped with a lighting system other than headlights, suitable for illuminating at least part of a space E inside the platform 9, i.e., the volume delimited by the guardrail, including at least part of the access zone 93, such that an operator located outside the platform 9 can identify the latter in the dark and access it without danger, and to facilitate the work of operators on the platform under low lighting conditions.

The lighting system of the platform 9 therefore comprises a first lighting device comprising at least one light source, provided on a part of the guardrail 92 separated from the work zone, and oriented toward the inside of the platform 9. The lighting intensity provided by the first lighting system is medium or low, i.e., preferably comprised between one and five lux at two meters.

In the illustrated example, the first lighting device comprises two light sources 100 and 101, for example light-emitting diodes (hereinafter LEDs), fastened on the control console 94 and which illuminate the inner zone E of the platform 9, the access zone 93 of the platform 9 while forming light beams F1 and F2. In FIG. 4, the beams F1 and F2 are combined. The beams F1 and F2 are oriented in a horizontal direction, toward an outer side of the aerial lift 1, i.e., toward the section 92a. Advantageously, the light sources 100 and 101 are adapted so that the beams F1 and F2 illuminate the entire section 92a.

The fact that the light sources 100 and 101 are provided on the control console 94 makes it possible to avoid exposing them to any impacts, since they are not on the sides of the guardrail 92 corresponding to the sections 92a, 92c and 92d, where the impacts with an outside element could occur.

The integration of the light sources 100 and 101 on the control console 94 makes it possible to minimize the cable length necessary to supply them with electricity.

The light sources 100 and 101 are each fastened below a rim 941 of the control console 94, in order to be protected from impacts coming from above. The platform 9 further comprises mechanical structures for protecting light sources 100 and 101, for example formed by metal bars 106 and 107 arranged around the control console 94 and able to be connected to the guardrail 92.

The first lighting device also illuminates the immediate environment of the platform 9 such that an operator present on the platform 9 is able to move the platform 9 relative to the chassis 3 and the turret 5 in an unlit environment. In other words, the lighting system is suitable for illuminating, at a medium or low intensity, the surroundings of the platform 9 so as to identify any obstacles early enough. The beams F1 and F2 for example make it possible to illuminate a vertical wall M located in the immediate environment of the platform 9, such that the operator controlling the movement of the platform 9 relative to the chassis 3 can make sure that the platform 9 does not collide with the wall M in the dark.

The maximum movement speed of the platform 9 relative to the ground is generally limited to 0.7 meters per second when the lift structure 7 is deployed. The light beams F1 and F2 are suitable for illuminating the immediate environment of the platform 9 up to a determined distance relative to the platform 9, for example two meters. This distance and an illumination intensity comprised between 1 and 5 lux at two meters are sufficient to immobilize the platform 9 in front of an obstacle. The lifting movements of the platform are done at a maximum speed of 0.4 m/s, and the rotation of the turret 5 is done at a maximum speed of 0.7 km/h. Such illumination differs from a work projector, which illuminates a specific zone with a high intensity, i.e., at least equal to twenty lux at two meters, allowing an operator to perform a specific task, or a headlight, suitable for illuminating the environment located on the ground in front of the chassis of a vehicle when it moves, and not the immediate environment of the vehicle, which remains dark. The first lighting device is not used in the movement configuration relative to the ground with the lift structure 7 folded, since the speed is higher and requires headlights.

The lighting system of the platform 9 also comprises a second lighting device suitable for illuminating the control console 94. The control console 94 contains lighted indicators, switches, and one or several manual control members 94a, 94b and 94c making it possible to control functionalities of the aerial lift 1. The control console 94 must be usable by an operator located on the platform 9 in case of low light. The second lighting device therefore comprises at least one light source fastened on the control console 94. In the illustrated example, the second lighting device comprises two light sources 104 and 105 fastened on the control console 94, on either side of a central island 95.

The control console 94 advantageously comprises a foldable protective cover 96 making it possible to protect the control members and the other components outside usage ranges of the aerial lift 1. The cover 96 is shown open in FIGS. 1, 2 and 3. An inner face of the foldable cover 96 comprises reflective surfaces 97 located across from light sources 104 and 105 such that the reflective surfaces 97 diffuse the light produced by the light sources 104 and 105 on the control console 94, as shown by the light flows F3 and F4 in FIG. 3, which allows the operator to distinguish the control console 94 clearly enough to view the state of the machine and use the switches and manual control members in the low lighting configuration.

The lighting system also comprises a third lighting device suitable for illuminating the immediate environment of the platform 9 located below the platform 9. This third lighting device advantageously comprises a light source 103, for example an LED, that projects a light beam F5 oriented downward and making it possible to illuminate an obstacle located below the platform 9, for example a roof T of a building near which the aerial lift 14 is used. The light source 103 is preferably fastened below the floor 90.

The three lighting devices described above can be equipped with other types of light sources to replace LEDs, and comprise different numbers of light sources while performing the same functions.

The lighting system of the platform 9 may incorporate only the first lighting device or only the second lighting device.

Optionally, the lower part is also equipped with a control console 50, for example provided on one side of the turret 5, accessible by a person located on the ground, and in particular making it possible to start the aerial lift 1, and control certain movements of the platform 9 in case of emergency. The control console 50 is provided with a lighting device 52, which may comprise one or several light sources, such as LEDs.

From the control console 50, an operator can decide to transfer control of the lift basket 1 to the control console 94 the platform 9, which will activate the illumination of the platform 9 such that the operator can access it. Indeed, for aerial lifts whereof the lift structure 7 is very long, the operator may have to travel several meters to access the platform 9. In such a case, the illumination of part of the platform 9 allows the operator to move easily in the dark toward the platform 9, identify the access zone 93 and access it.

The invention is not limited to an aerial lift with turret and articulated arm as shown in this example, and is also applicable to all types of aerial lifts for personnel, in particular lift structures of the type with a telescoping arm, scissor and vertical mast and lifts mounted on a truck chassis or a trailer chassis.

A person located on the platform and needing to steer the maneuvering of the platform and the aerial lift at a height or relative to the ground is capable of distinguishing any obstacles in the environment near the lift basket.

According to one embodiment of the invention, not shown, the first and second lighting devices can form one single lighting device suitable for simultaneously illuminating the access zone to the platform, the outside environment and the control console.

The features of the embodiments and alternatives described above may be combined to form new embodiments of the invention.

1. An aerial lift including:
a lower part equipped with members for connecting to the ground;
a platform comprising a floor partially surrounded by a guardrail in which an access zone is arranged;
a lift structure supporting the platform;
characterized in that wherein the platform is equipped with a lighting system, other than headlights, suitable for illuminating at least part of a space inside the platform, including at least the access zone.

2. The aerial lift according to claim 1, wherein the lighting system of the platform comprises a first lighting device comprising at least one light source provided on a part of the guardrail separated from work zones of the platform, and emitting a beam of light oriented toward the inside of the platform.

3. The aerial lift according to claim 2, wherein the platform comprises a control console mounted on the part of the guardrail separated from the work zones, and wherein the light source of the first lighting device is fastened on the control console.

4. The aerial lift according to claim 2, wherein the first lighting device is also suitable for lighting the immediate environment of the platform such that an operator present on the platform is able to move the platform relative to the lower part in an unlit environment.

5. The aerial lift according to claim 4, wherein the first lighting device illuminates the immediate environment of the platform located at the same height relative to the ground as the platform and in a horizontal direction, up to a distance of the platform at least equal to two meters.

6. The aerial lift according to claim 1, wherein the platform comprises a control console, and wherein the lighting system of the platform comprises a second lighting device suitable for illuminating the control console.

7. The aerial lift according to claim 6, wherein the control console comprises a foldable protective cover, the inner side of which comprises reflective surfaces, suitable for diffusing, on the control console, the light produced by the second lighting device when the protective cover is in a raised position providing access to the control console.

8. The aerial lift according to claim 7, wherein the second lighting device comprises at least one light source fastened on the control console.

9. The aerial lift according to claim 1, wherein the platform comprises a third lighting device suitable for illuminating the immediate environment of the platform located below the platform.

10. The aerial lift according to claim 9, wherein the third lighting device comprises at least one light source fastened below a floor of the platform.

11. The aerial lift according to claim 1, wherein the activation of the lighting system of the platform can be controlled remotely from the lower part.

12. The aerial lift according to claim 11, wherein the lower part is equipped with a control console from which the activation of the lighting system of the platform is controlled, and wherein the control console of the lower part is equipped with a device for lighting this control console.

13. The aerial lift according to claim 3, wherein the first lighting device is also suitable for lighting the immediate environment of the platform such that an operator present on the platform is able to move the platform relative to the lower part in an unlit environment.

14. The aerial lift according to claim 2, wherein the platform comprises a control console, and wherein the lighting system of the platform comprises a second lighting device suitable for illuminating the control console.

15. The aerial lift according to claim 3, wherein the platform comprises a control console, and wherein the lighting system of the platform comprises a second lighting device suitable for illuminating the control console.

16. The aerial lift according to claim 4, wherein the platform comprises a control console, and wherein the lighting system of the platform comprises a second lighting device suitable for illuminating the control console.

17. The aerial lift according to claim 5, wherein the platform comprises a control console, and wherein the lighting system of the platform comprises a second lighting device suitable for illuminating the control console.

18. The aerial lift according to claim 2, wherein the platform comprises a third lighting device suitable for illuminating the immediate environment of the platform located below the platform.

19. The aerial lift according to claim 3, wherein the platform comprises a third lighting device suitable for illuminating the immediate environment of the platform located below the platform.

20. The aerial lift according to claim 4, wherein the platform comprises a third lighting device suitable for illuminating the immediate environment of the platform located below the platform.
